(19) United States
(12) Patent Application Publication
(10) Pub. No.: US 2003/0002209 A1
(43) Pub. Date: Jan. 2, 2003

(54) Detent structure for removable disk cartridge

(75) Inventor: Kevin Yang, Taipei (TW)

Correspondence Address: DAVID E DOUGHERTY, DENNISON SCHULTZ & DOUGHERTY, 612 CRYSTAL SQUARE 4, 1745 JEFFERSON DAVIS HIGHWAY, ARLINGTON, VA, 22202, US

(73) Assignee: Advanced System & Storage Corp.

(21) Appl. No.: 09/893,442

(22) Filed: Jun. 29, 2001

(51) Int. Cl. G11B 17/04

(52) U.S. Cl. 360/99.06

(57) ABSTRACT

A detent structure for a removable disk cartridge comprising a removable cartridge and a receiving seat, the cartridge is fixedly provided in the front thereof with a handle, a press member with a similar shape to that of the handle is provided inside of the handle, the press member is connected with the cartridge by means of a spring and synchronically controls a detent member provided on and protruding out of the cartridge, the detent member also has a spring connecting to the cartridge. The receiving seat has on both sides thereof an engaging hole to allow the cartridge to fit in the receiving seat; the detent member can be firmly engaged therein to prevent the cartridge from drawing out. When the press member is pressed, the detent member is retracted inwardly to relieve engagement of the engaging holes to allow removing of the cartridge. Bearing surfaces are formed inside of the cartridge from rubber sheets connected with the cartridge; therefore, the cartridge has a good vibration-proofing effect.

### BACKGROUND OF THE INVENTION

1. Field of the Invention

The present invention is related to a detent structure for a removable disk cartridge, and especially to such a structure which can allow easy drawing out of a disk cartridge with one action, and suits removable hardware of computers such as a disk drive.

2. Description of the Prior Art

Following popularization of application of computers, information of computer widely communicates. By now generally, capacities of whichever of computer software and computer information are more and more larger, more diskettes are needed to store information. In storing, plural diskettes not only are inconvenient for use, but also are subjected to missing something. Although capacities of diskettes are larger and the diskettes are convenient for carrying, storing of the information still requires special equipment such as a CD burner; thereby, removable disk cartridges with large capacities are developed.

A conventional structure of a removable disk cartridge mainly is comprised of: a housing for a hard disk, a hard disk cover and a receiving seat, wherein, the housing for the hard disk is a rectangular housing with an opened top, a handle seat is provided at both sides of the middle of the front surface thereof to embed therein a handle. The handle is in the shape of “U”, an upwardly protruding member is provided on both sides of the housing, these two sides also are provided each with a slide slot and a protrusion of the cover, and bus line pins are provided on the back side thereof. The housing for a hard disk can be exactly fitted over the hard disk to protect it. The hard disk cover is designed in correspondence with the housing for the hard disk; thereby, when in removing the hard disk, it needs only to move the handle upwardly to take out the housing for the hard disk through the front side by the principle of lever, to release the pins and remove the hard disk.

However, the above stated structure shall have the housing for the hard disk provided with additional two handle seats although the housing for the hard disk can be taken out by moving the handle upwardly, and thereby is more cumbersome in production. Besides, when the hard disk is placed into the housing for the hard disk, there is no clear mark to show sure engagement. Thereby, such structure is undesired.

### SUMMARY OF THE INVENTION

In view of this, it is the goal of the present invention to get rid of the defects resided in the conventional structure having been publicly used; and to provide a detent structure for a removable disk cartridge, with which, a simple press structure is used easily to remove the housing for a hard disk and can be clearly aware of complete connecting and mounting of the housing for the hard disk in the frame of a computer.

Thereby, the primary object of the present invention is to provide a simple press structure on a detent structure for a removable disk cartridge to remove the housing for a hard disk conveniently from the frame of the computer.

The secondary object of the present invention is to provide a detent structure for a removable disk cartridge by which it can be clearly aware of complete connecting and mounting of the housing for the hard disk in the frame of a computer.

In order to obtain the above stated objects, the present invention is comprised mainly of a removable cartridge and a receiving seat, the removable cartridge is fixedly provided in the front thereof with a handle, a press member with a similar shape to that of the handle is provided inside of the handle, the press member is connected with the removable disk cartridge by means of a spring and synchronically controls a detent member provided on and protruding out of the removable cartridge, the detent member is also provided with a spring connecting with the removable cartridge. The receiving seat is provided on both sides thereof with an engaging hole to allow the removable cartridge to fit in the receiving seat, and the detent member can be firmly engaged therein to prevent the removable cartridge from drawing out. When the press member is pressed, the detent member is brought to retract inwardly synchronically to relieve engagement of the engaging holes to allow removing of the removable cartridge. And bearing surfaces are formed inside of the removable cartridge from rubber sheets connected with the removable cartridge; therefore, the removable cartridge has a good vibration-proofing effect.

The present invention will be apparent in its novelty and particular structural characteristics after reading the detailed description of the preferred embodiment thereof in reference to the accompanying drawings.

### BRIEF DESCRIPTION OF THE DRAWINGS

FIG. 1 is a perspective view of an embodiment of the present invention;

FIG. 2 is an analytical perspective view of the elements in the embodiment of the present invention;

FIG. 3 is a schematic view showing the positions of a removable disk cartridge and a receiving seat in the present invention;

FIG. 4 is a schematic view showing the removable disk cartridge is drawn out of the receiving seat of the present invention.

### DETAILED DESCRIPTION OF THE PREFERRED EMBODIMENT

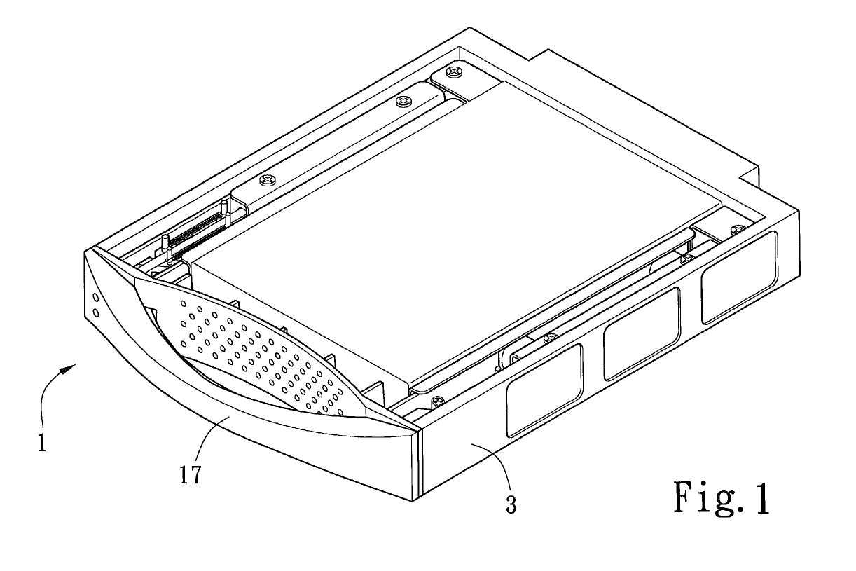

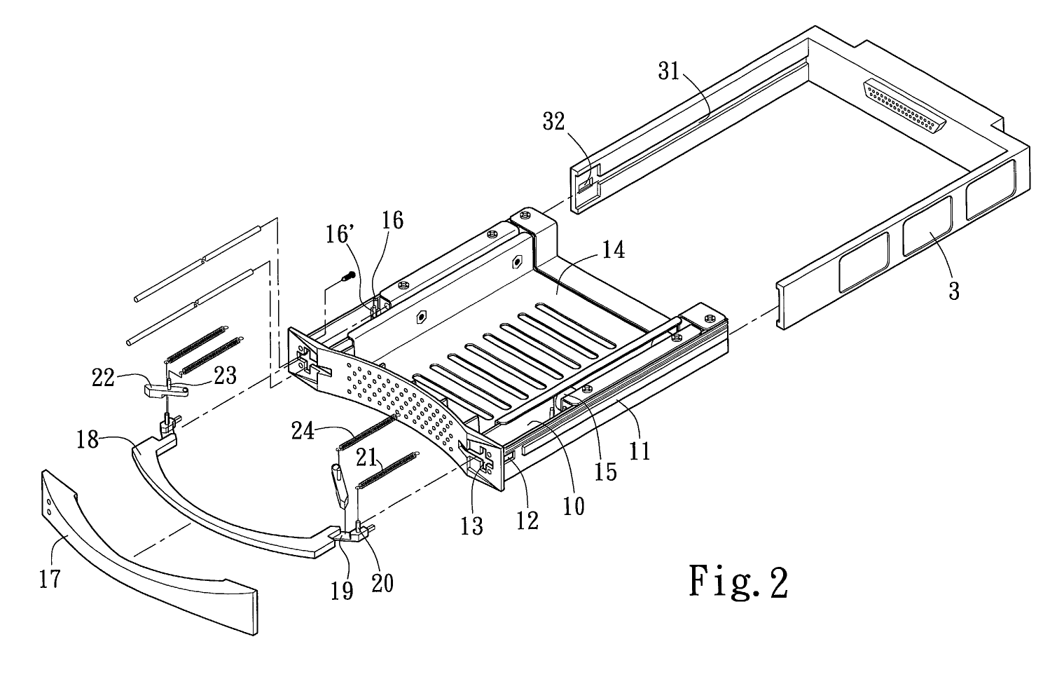

Referring firstly to FIGS. 1 and 2, the present invention is comprised mainly of a removable disk cartridge 1 and a receiving seat 3, the removable disk cartridge 1 is provided with a frame 10 in the shape of “∩” which is provided on both the outer lateral sides thereof with a slide rail 11, each slide rail 11 is provided at the rear thereof with a through hole 12, the inner sides opposite to the aforesaid outer lateral sides are provided with bearing surfaces 14 with a plurality of rubber stubs 15. The frame 10 in the shape of “∩” is provided on the inner sides thereof near by the through holes 12 with a plurality of vertical posts 16, 16′, the frame 10 has a middle front panel connected to both the lateral sides thereof and is provided with a plurality of through holes 13 which are provided for extending of a press member 18 in the shape of “∩” and two transparent pipes therethrough. The two ends of the press member 18 each is extended to form a folded portion having a recess 19 thereon and provided on its end with a vertical post 20. Each vertical post 20 is connected by means of a spring 21 to the vertical post 16 of the frame 10 in the shape of “∩”, and an elongate detent member 22 is stacked on each recess 19 of the press member 18 and is pivotally provided on each inner side of the frame 10. The detent member 22 is also provided thereon with a vertical post 23 which is also connected by means of a spring 24 to the vertical post 16′ of the frame 10, in order that both the detent members 22 are extended through to protruding out of the through holes 12 provided on the inner sides of the frame 10 in the shape of “∩” normally. And the frame 10 in the shape of “∩”, is fixedly connected by means of the middle front panel thereof with a handle 17. The handle 17 has two through holes on the ends thereof respectively to connect with the two transparent pipes extending out of the through holes 13. When LED's at the rear ends of the transparent pipes are lightened, light from them can be led to the location where the handle 17 is, the handle 17 is provided on the inside thereof with a recess for moving of the press member 18.

The receiving seat 3 has a similar shape to that of the removable disk cartridge 1, i.e., in the shape of “∩”, and is provided on two sides thereof each with a slide slot 31, the front ends of the slide slots 31 are provided at suitable positions (corresponding to the positions of the two through holes 12 of the removable disk cartridge 1) with engaging holes 32.

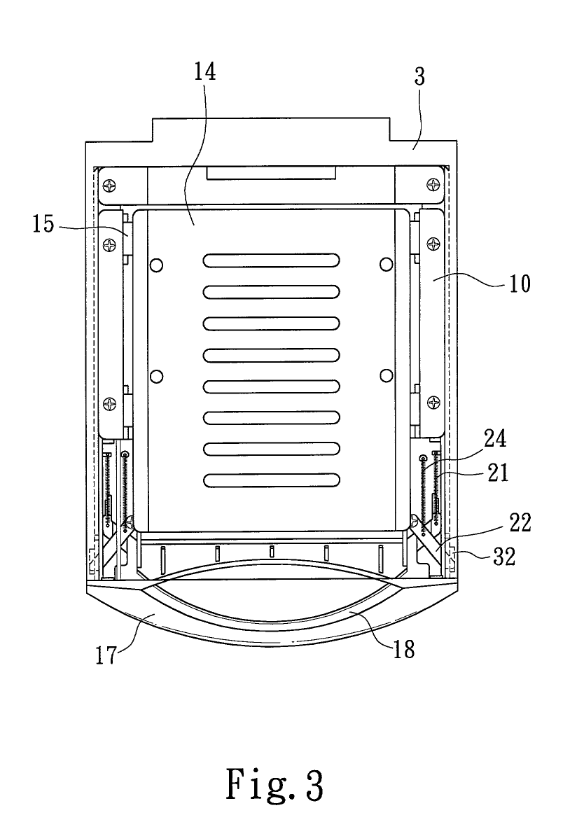

As shown in FIG. 3, when the removable disk cartridge 1 is to connect with the receiving seat 3, it needs only to align the slide rails 11 on the two sides of the removable disk cartridge 1 with the slide slots 31 provided on the two sides of the receiving seat 3, by the fact that the detent member 22 is limited by the spring 24 so as not to protrude outwardly; and when the removable disk cartridge 1 is pushed inwardly, both the detent members 22 slightly retract along the slide slots 31 provided on the two sides of the receiving seat 3, when the removable disk cartridge 1 is completely pushed in, the detent members 22 slide into the engaging holes 32 and are detained thereby, thus operation of connection is completed.

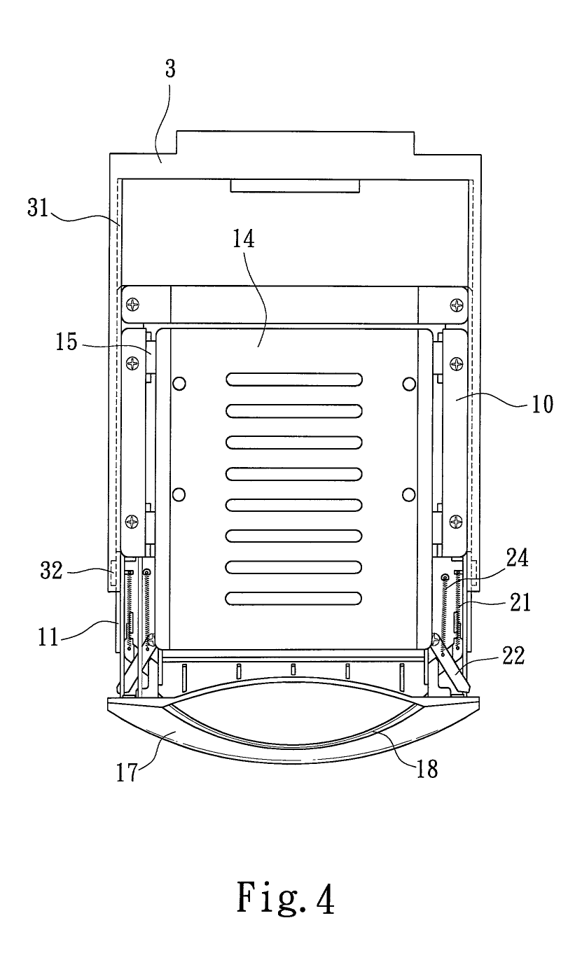

Referring to FIG. 4, when the removable disk cartridge 1 is to be drawn out for carrying, by virtue that the press member 18 is provided inside of the handle 17, when the handle 17 is held with a hand, fingers can naturally press the press member 18 to move it rearwardly, now the recess 19 provided on both sides of the press member 18 automatically moves the detent member 22 inwardly to retract the latter to get out of the engaging holes 32 of the receiving seat 3, and detention action of the detent member 22 disappears, just to exert a force rearwardly, the removable disk cartridge 1 can be taken out easily.

And more, the bearing surfaces 14 inside of the removable disk cartridge 1 are connected with the frame 10 in the shape of “∩” by means of a plurality of rubber stubs 15 which have a good vibration absorbing effect, thereby, vibration created when the disk is running can all be absorbed by the rubber stubs 15.

In conclusion, the detent structure for a removable disk cartridge of the present invention synchronically moves the detent member by providing a simple press structure to render the removable disk cartridge to be drawn out more easily; and when in insertion in, firm connection of the removable disk cartridge can be clearly known; and vibration created can all be absorbed by the rubber stubs, an effect of vibration proofing can be obtained. Further, the entire space modeling of the removable disk cartridge in comparing to the structure of a conventional removable disk cartridges is novel. The detent structure for a removable disk cartridge of the present invention is evidently improved in effects.

The above stated structure is only for illustrating a preferred embodiment and not for giving any limitation to the scope of the present invention. It will be apparent to those skilled in this art that various modifications or changes can be made to the elements of the present invention, and all such modifications and changes also fall within the scope of the appended claims and are intended to form part of this invention.

What is claimed is

1. A detent structure for a removable disk cartridge, said structure comprises a removable disk cartridge and a receiving seat, said removable disk cartridge is fixedly provided in the front thereof with a handle, a press member with a similar shape to that of said handle is provided inside of said handle, said press member is connected with said removable disk cartridge by means of a spring and synchronically controls a detent member provided on and protruding out of said removable disk cartridge, said detent member is also provided with a spring connecting with said removable disk cartridge, said receiving seat is provided on both sides thereof with an engaging hole to allow said removable disk cartridge to fit in said receiving seat, and said detent member is firmly engaged therein to prevent said removable disk cartridge from drawing out; when said press member is pressed, said detent member is brought to retract inwardly synchronically to relieve engagement of said engaging holes to allow removing of said removable cartridge.

2. A detent structure for a removable disk cartridge as in claim 1, wherein, two ends of said press member each is extended to form a folded portion having a recess for stacking of an elongate detent member thereon.

3. A detent structure for a removable disk cartridge as in claim 1, wherein, said removable disk cartridge is provided on the two sides thereof with two through holes provided on the inner sides of said removable disk cartridge normally in order that said detent members are extended through to protruding out of said through holes.

4. A detent structure for a removable disk cartridge as in claim 1, wherein, bearing surfaces are provided inside of said removable disk cartridge and are formed from rubber sheets connected with said removable cartridge.
